(19) United States
(12) Patent Application Publication
(10) Pub. No.: US 2026/0171736 A1
(43) Pub. Date: Jun. 18, 2026

(54) CABLE NETWORK BASED HOUSING WITH IMPROVED SIGNAL INTEGRITY

(71) Applicant: ARRIS Enterprises LLC, Horsham, PA (US)

(72) Inventor: David BOWLER, Stow, MA (US)

(73) Assignee: ARRIS Enterprises LLC, Horsham, PA (US)

(21) Appl. No.: 19/126,915

(22) PCT Filed: Nov. 2, 2023
(86) PCT No.: PCT/US2023/036712

§ 371 Date: May 2, 2025

Related U.S. Application Data
(60) Provisional application No. 63/422,358, filed on Nov. 3, 2022.

(51) Int. Cl. H01R 24/52; H01R 24/44; H01R 103/00; H04N 7/10

(52) U.S. Cl. CPC H01R 24/52; H01R 24/44; H04N 7/10; H01R 2103/00

(57) ABSTRACT

An interconnection for a cable network-based housing with improved signal integrity.

### CROSS REFERENCE TO RELATED APPLICATIONS

The present application claims priority to U.S. Provisional Application No. 63/422,358 filed Nov. 3, 2022, the contents of which are each incorporated herein by reference in their entirety.

### BACKGROUND

The subject matter of this application relates to signal integrity for cable distribution networks.

Cable Television (CATV) services provide content to large groups of customers (e.g., subscribers) from a central delivery unit, generally referred to as a “head end,” which distributes channels of content to its customers from this central delivery unit through an access network comprising a hybrid fiber coax (HFC) cable plant, including associated components (nodes, amplifiers and taps). Modern Cable Television (CATV) service networks, however, not only provide media content such as television channels and music channels to a customer, but also provide a host of digital communication services such as Internet Service, Video-on-Demand, telephone service such as VoIP, home automation/security, and so forth. These digital communication services, in turn, require not only communication in a downstream direction from the head end, through the HFC, typically forming a branch network and to a customer, but also require communication in an upstream direction from a customer to the head end typically through the HFC network.

To this end, CATV head ends have historically included a separate Cable Modem Termination System (CMTS), used to provide high speed data services, such as cable Internet, Voice over Internet Protocol, etc. to cable customers and a video headend system, used to provide video services, such as broadcast video and video on demand (VOD). Typically, a CMTS will include both Ethernet interfaces (or other more traditional high-speed data interfaces) as well as radio frequency (RF) interfaces so that traffic coming from the Internet can be routed (or bridged) through the Ethernet interface, through the CMTS, and then onto the RF interfaces that are connected to the cable company's hybrid fiber coax (HFC) system. Downstream traffic is delivered from the CMTS to a cable modem and/or set top box in a customer's home, while upstream traffic is delivered from a cable modem and/or set top box in a customer's home to the CMTS. The Video Headend System similarly provides video to either a set-top, TV with a video decryption card, or other device capable of demodulating and decrypting the incoming encrypted video services. Many modern CATV systems have combined the functionality of the CMTS with the video delivery system (e.g., EdgeQAM—quadrature amplitude modulation) in a single platform generally referred to an Integrated CMTS (e.g., Integrated Converged Cable Access Platform (CCAP))—video services are prepared and provided to the I-CCAP which then QAM modulates the video onto the appropriate frequencies. Still other modern CATV systems generally referred to as distributed CMTS (e.g., distributed Converged Cable Access Platform) may include a Remote PHY (or R-PHY) which relocates the physical layer (PHY) of a traditional Integrated CCAP by pushing it to the network's fiber nodes (R-MAC PHY relocates both the MAC and the PHY to the network's nodes). Thus, while the core in the CCAP performs the higher layer processing, the R-PHY device in the remote node converts the downstream data sent from the core from digital-to-analog to be transmitted on radio frequency to the cable modems and/or set top boxes, and converts the upstream radio frequency data sent from the cable modems and/or set top boxes from analog-to-digital format to be transmitted optically to the core.

### BRIEF DESCRIPTION OF THE DRAWINGS

For a better understanding of the invention, and to show how the same may be carried into effect, reference will now be made, by way of example, to the accompanying drawings, in which:

FIG. 1 illustrates an integrated Cable Modem Termination System.

FIG. 2 illustrates a distributed Cable Modem Termination System.

FIG. 3 illustrates a bridger with a tray.

FIG. 4 illustrates the interior of the bridger of FIG. 3 with four port entry adapters.

FIG. 5 illustrates a pictorial view of the exterior of the bridger of FIG. 3.

FIG. 6 illustrates a view of the base of the tray of the bridger of FIG. 3.

FIG. 7 illustrates the port entry adapter of the bridger of FIG. 3.

FIG. 8 illustrates threaded mounts of the bridger of FIG. 3.

FIG. 9 illustrates a pictorial view of the port entry adapter of the bridger of FIG. 3.

FIG. 10 illustrates a pictorial view of a portion of the port entry adapter of the bridger of FIG. 3.

FIG. 11 illustrates an exploded view and cut away view and an exploded view of the port entry adapter of the bridger of FIG. 3.

FIG. 12 illustrates the port entry adapter of the bridger of FIG. 3.

FIG. 13 illustrates a line extender with a tray.

FIG. 14 illustrates the interior of the line extender of FIG. 13 with two port entry adapters.

FIG. 15 illustrates a pictorial view of the exterior of the line extender of FIG. 13.

FIG. 16 illustrates a view of the base of the tray of the line extender of FIG. 13.

FIG. 17 illustrates the port entry adapter of the line extender of FIG. 13.

FIG. 18 illustrates threaded mounts of the line extender of FIG. 13.

FIG. 19 illustrates a pictorial view of the port entry adapter of the line extender of FIG. 13.

FIG. 20 illustrates a pictorial view of a portion of the port entry adapter of the bridger of FIG. 3.

FIG. 21 illustrates pictorial and cut away views of the line extender of FIG. 13.

FIG. 22 illustrates a modified port entry adapter.

FIG. 23 illustrates the port entry adapter of FIG. 22 together with a compressible conductor.

FIG. 24 illustrates a cross sectional view of the port entry adapter of FIG. 22, housing, electronics, and cable.

FIG. 25 illustrates resilient prongs of the port entry adapter of FIG. 22.

FIG. 26 illustrates a sectional view of the port entry adapter of FIG. 22.

FIG. 27 illustrates an exploded view of the port entry adapter of FIG. 22.

FIG. 28 illustrates another modified port entry adapter.

FIG. 29 illustrates a cross sectional view of the port entry adapter of FIG. 28, housing, electronics, and cable.

### DETAILED DESCRIPTION

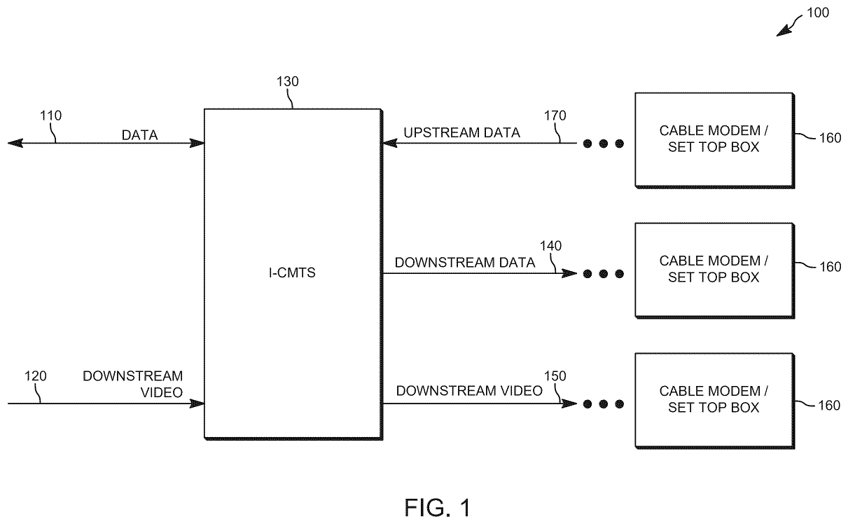

Referring to FIG. 1, an integrated CMTS (e.g., Integrated Converged Cable Access Platform (CCAP)) 100 may include data 110 that is sent and received over the Internet (or other network) typically in the form of packetized data. The integrated CMTS 100 may also receive downstream video 120, typically in the form of packetized data from an operator video aggregation system. By way of example, broadcast video is typically obtained from a satellite delivery system and pre-processed for delivery to the subscriber though the CCAP or video headend system. The integrated CMTS 100 receives and processes the received data 110 and downstream video 120. The CMTS 130 may transmit downstream data 140 and downstream video 150 to a customer's cable modem and/or set top box 160 through a RF distribution network, which may include other devices, such as amplifiers and splitters. The CMTS 130 may receive upstream data 170 from a customer's cable modem and/or set top box 160 through a network, which may include other devices, such as amplifiers and splitters. The CMTS 130 may include multiple devices to achieve its desired capabilities.

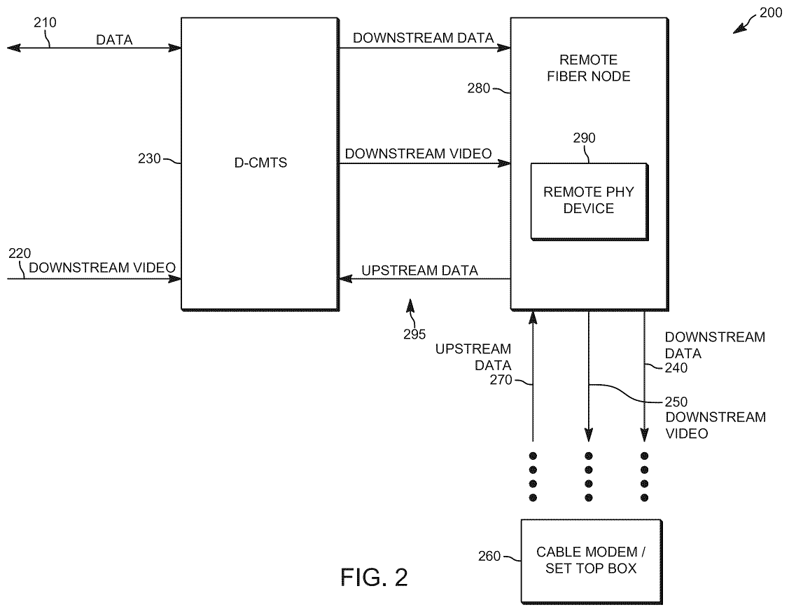

Referring to FIG. 2, as a result of increasing bandwidth demands, limited facility space for integrated CMTSs, and power consumption considerations, it may be desirable to include a Distributed Cable Modem Termination System (D-CMTS) 200 (e.g., Distributed Converged Cable Access Platform (CCAP)). In general, the CMTS is focused on data services while the CCAP further includes broadcast video services. The D-CMTS 200 distributes a portion of the functionality of the I-CMTS 100 downstream to a remote location, such as a fiber node, using network packetized data. An exemplary D-CMTS 200 may include a remote PHY architecture, where a remote PHY (R-PHY) is preferably an optical node device that is located at the junction of the fiber and the coaxial. In general the R-PHY often includes the PHY layers of a portion of the system. The D-CMTS 200 may include a D-CMTS 230 (e.g., core) that includes data 210 that is sent and received over the Internet (or other network) typically in the form of packetized data. The D-CMTS 200 may also receive downstream video 220, typically in the form of packetized data from an operator video aggregation system. The D-CMTS 230 receives and processes the received data 210 and downstream video 220. A remote Fiber node 280 preferably includes a remote PHY device 290. The remote PHY device 290 may transmit downstream data 240 and downstream video 250 to a customer's cable modem and/or set top box 260 through a network, which may include other devices, such as amplifier and splitters. The remote PHY device 290 may receive upstream data 270 from a customer's cable modem and/or set top box 260 through a network, which may include other devices, such as amplifiers and splitters. The remote PHY device 290 may include multiple devices to achieve its desired capabilities. The remote PHY device 290 primarily includes PHY related circuitry, such as downstream QAM modulators, upstream QAM demodulators, together with pseudowire logic to connect to the D-CMTS 230 using network packetized data. The remote PHY device 290 and the D-CMTS 230 may include data and/or video interconnections, such as downstream data, downstream video, and upstream data 295. It is noted that, in some embodiments, video traffic may go directly to the remote physical device thereby bypassing the D-CMTS 230. In some cases, the remote PHY and/or remote MAC PHY functionality may be provided at the head end.

By way of example, the remote PHY device 290 may covert downstream DOCSIS (i.e., Data Over Cable Service Interface Specification) data (e.g., DOCSIS 1.0; 1.1; 2.0; 3.0; 3.1; and 4.0 each of which are incorporated herein by reference in their entirety), video data, out of band signals received from the D-CMTS 230 to analog for transmission over RF or analog optics. By way of example, the remote PHY device 290 may convert upstream DOCSIS, and out of band signals received from an analog medium, such as RF or linear optics, to digital for transmission to the D-CMTS 230. As it may be observed, depending on the particular configuration, the R-PHY may move all or a portion of the DOCSIS MAC and/or PHY layers down to the fiber node.

The cable network includes line extenders and bridgers, among other components that filter and/or amplify the signal to the customer premise equipment and from the customer premise equipment to the head end. The traditional frequency range supported for such components is up to 1.2 GHz frequency. For example, frequency ranges of 5 to 42 MHz in the upstream direction and 54 to 1218 MHz in the downstream direction, of 5 to 65 MHz in the upstream direction and 85 to 1218 MHz in the downstream direction, of 5 to 85 MHz in the upstream direction and 102 to 1218 MHz in the downstream direction, and of 5 to 204 MHz in the upstream direction and 258 to 1218 MHz in the downstream direction, are typically supported. In this manner, the components selectively filter and amplify the signals in the respective directions.

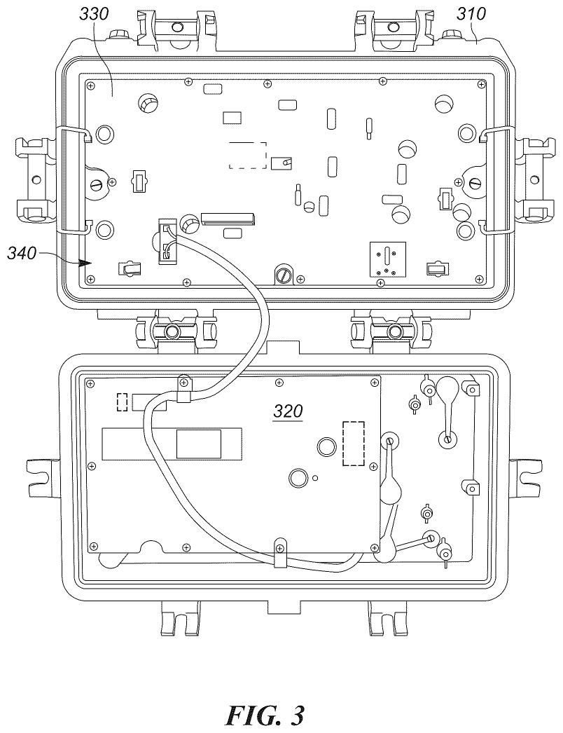

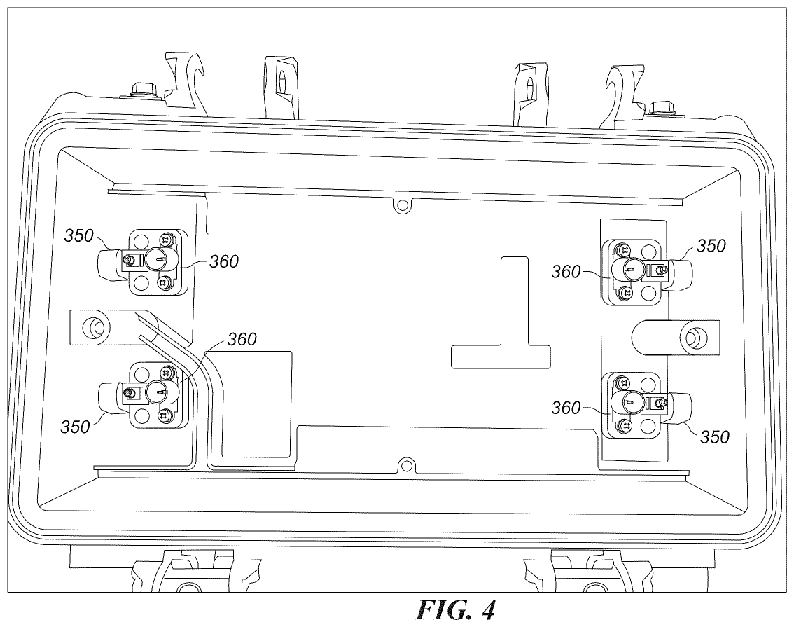

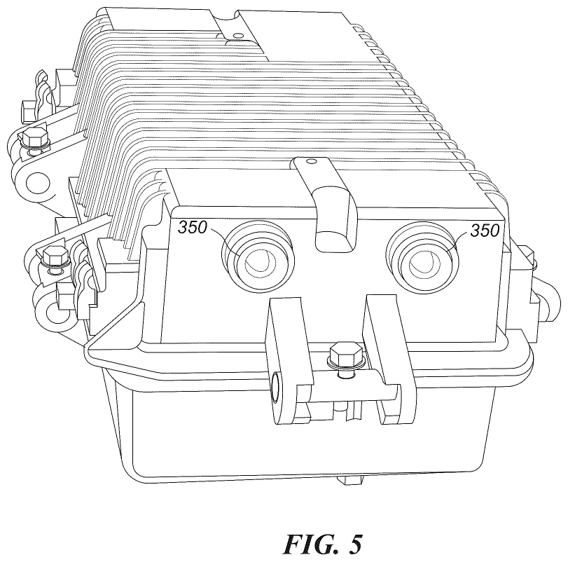

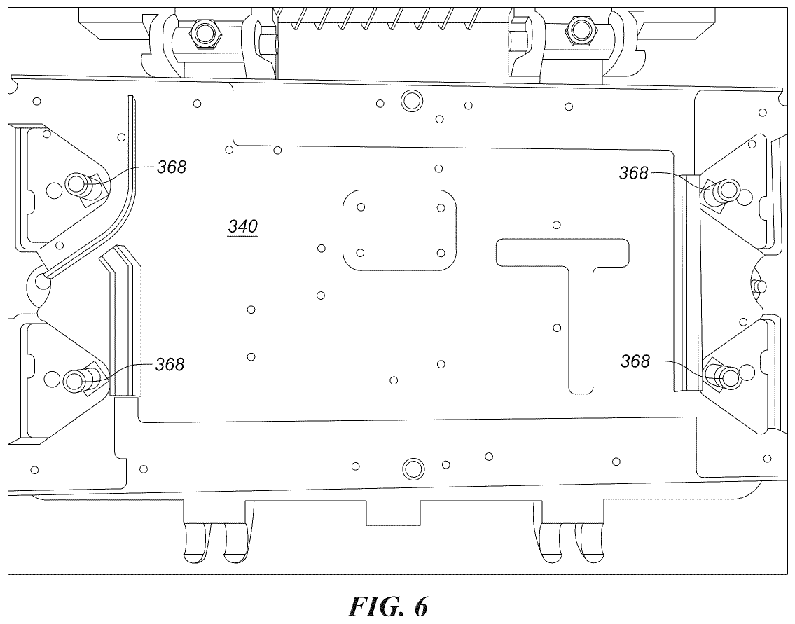

Referring to FIG. 3, a pictorial representation of a MiniBridger 300 (i.e., bridger) is illustrated. The MiniBridger 300 is a 1 to many configuration to provide multiple filter-amplified signals. The MiniBridger 300 includes a substantial housing 310, which is conductive, that is interconnected to the network cable. The MiniBridger 300 includes a power supply 320 attached to one half of the housing 310 and electronics 330 are attached to the other half of the housing 310. The electronics 330 are included in a detachably engageable tray 340 that may be removed from the housing 310. Referring also to FIG. 4, a set of one or more coaxial cables are interconnected to the MiniBridger 300, such as four cables through respective ports. Referring also to FIG. 5 and FIG. 6, the cables are inserted through a respective opening 350 in the housing and secured to a respective adapter 360 secured within the housing 310. Referring also to FIG. 6, the tray 340 of electronics 330 may include a corresponding set of connectors 368 that are detachably engageable with the adapters 360.

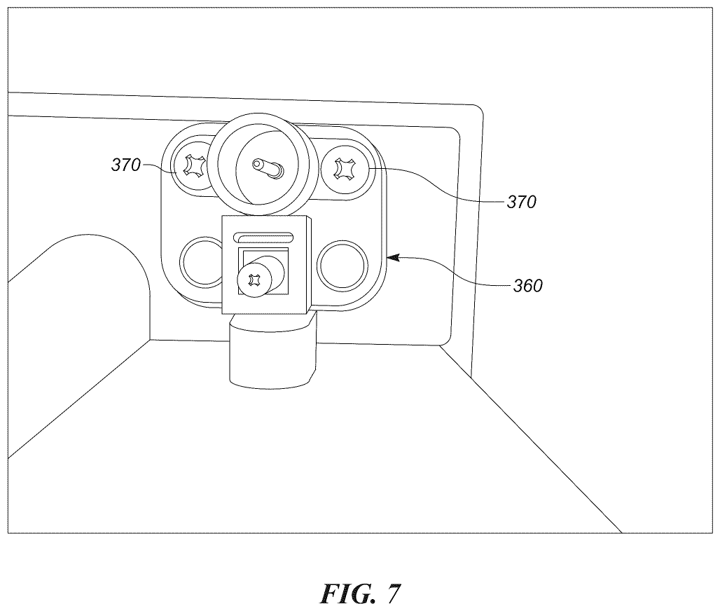

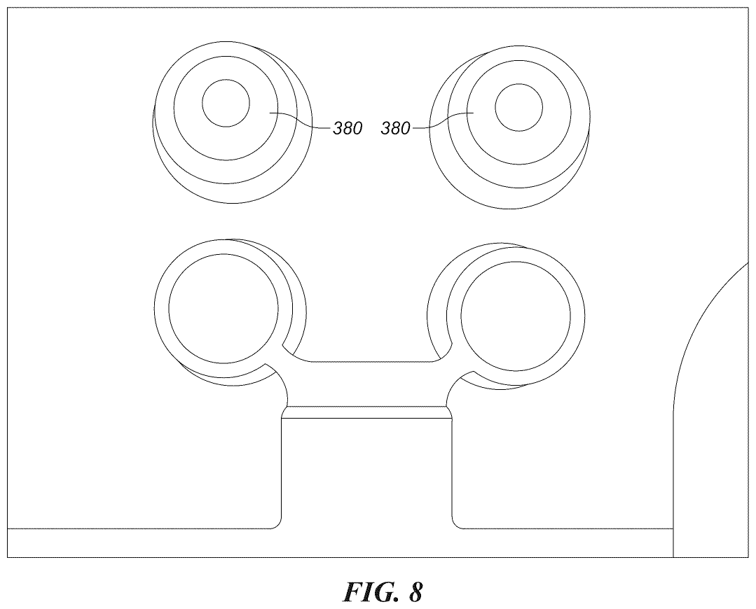

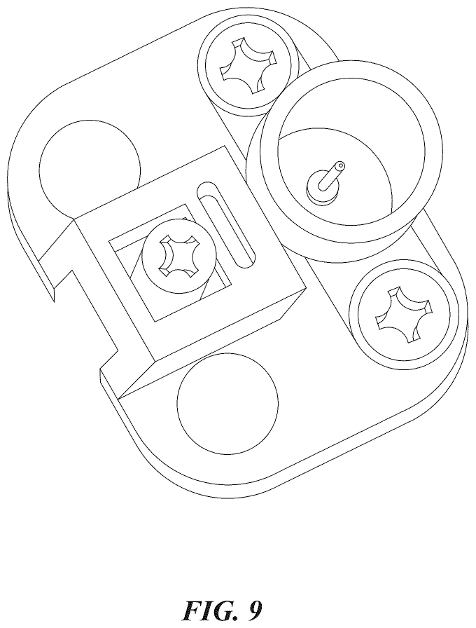

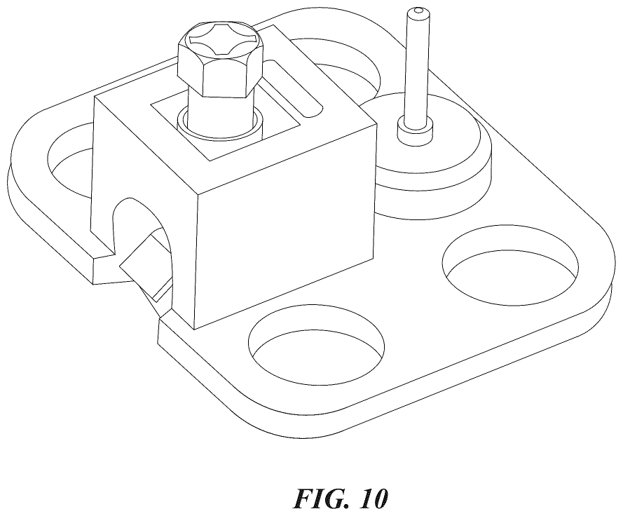

Referring to FIG. 7 and FIG. 8, the adapter 360 is secured to the housing by a pair of screws 370 into threaded mounts 380. In this manner the adapter 360 is secured to the housing in a manner that also inhibits rotation. Also referring to FIG. 9 and FIG. 10, the adapter 360 includes a central conductor that is engaged with the connector 368.

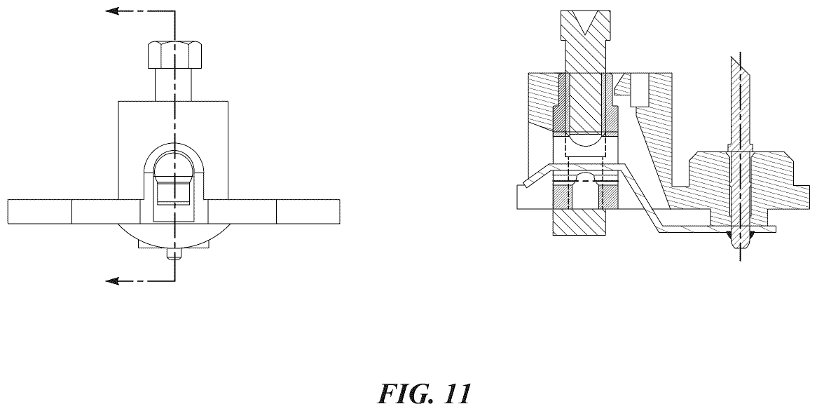

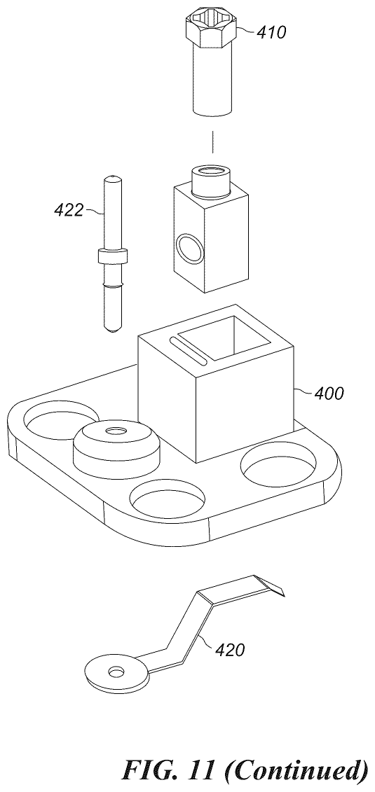

Further referring to FIG. 11, the adapter 360 receives the central “stinger” conductor of the cable with within a rectangular enclosure 400. The central “stinger” conductor is secured in place with a conductive threaded screw 410. The central “stinger” conductor is pressed onto a conductive flexible metal member 420 which forms a conductive path to a center prong 422 of a connector. The sheath of the coaxial cable, which provides a ground reference potential, is secured to the housing 310, which likewise provides the housing as a ground reference potential. The housing 310 is electrically interconnected to the threaded mounts 380, which are electrically interconnected to the screws 370, which are electrically interconnected to the exterior portion of the connector that includes the center prong. In this manner, the ground potential is provided from the sheath of the cable, through respective portions of the housing, to the electronics.

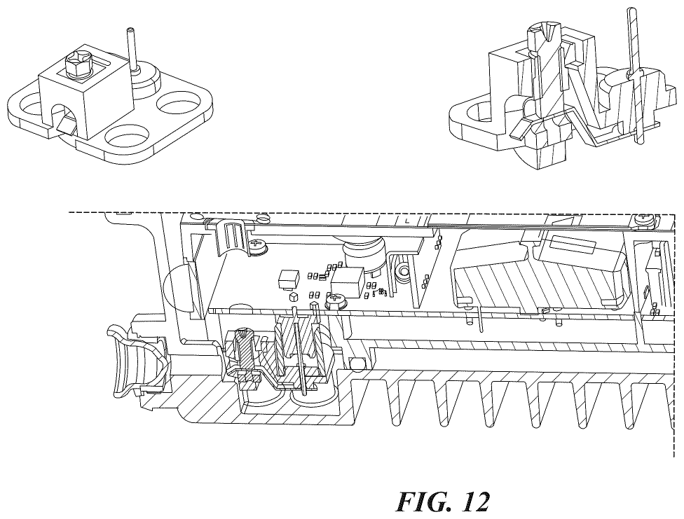

Referring to FIG. 12, the resulting port entry structure is illustrated showing the signal path and the ground path between the coaxial cable and the electronics enclosed therein.

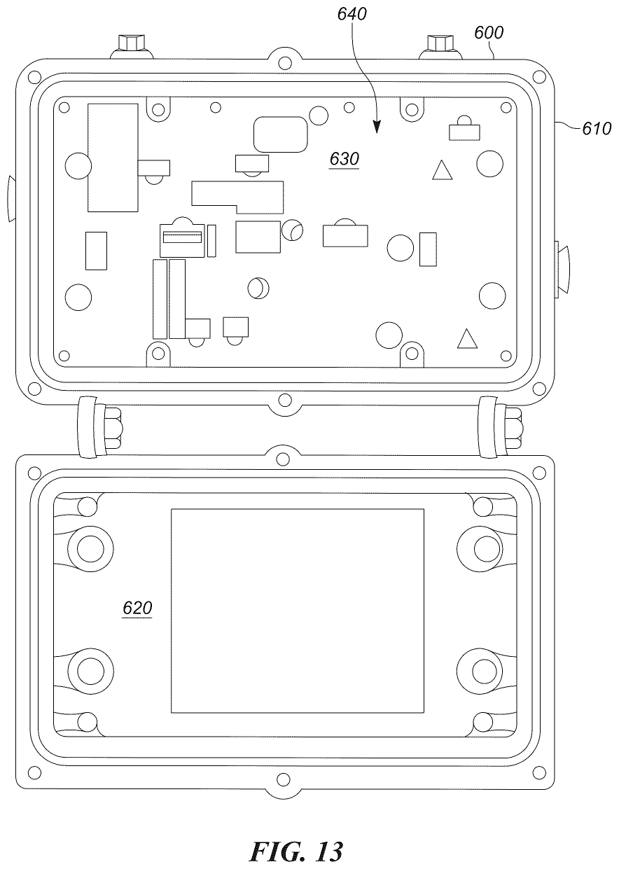

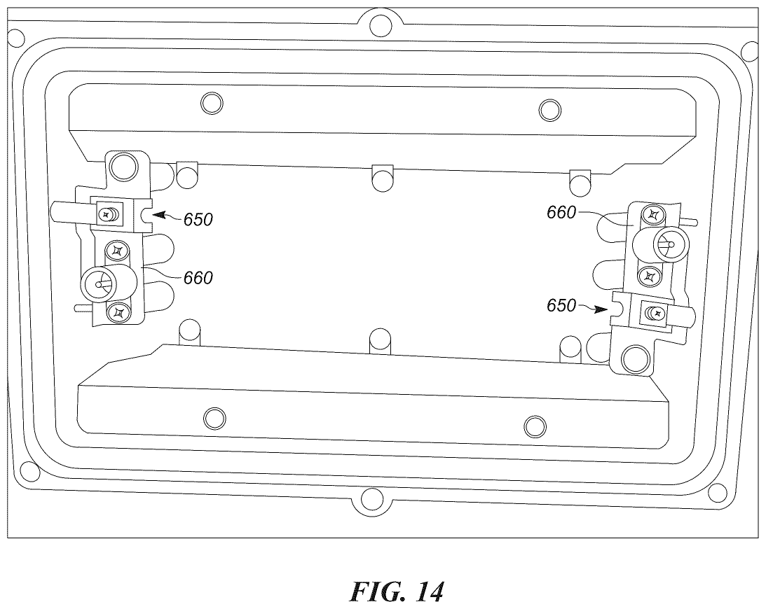

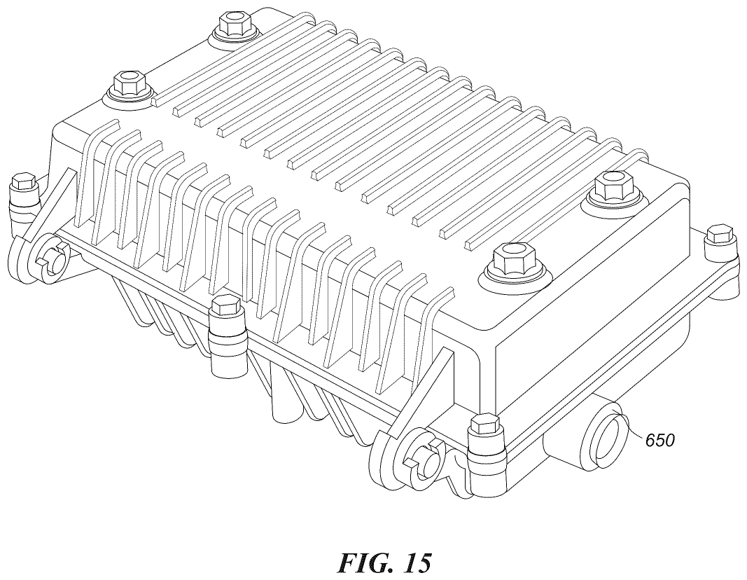

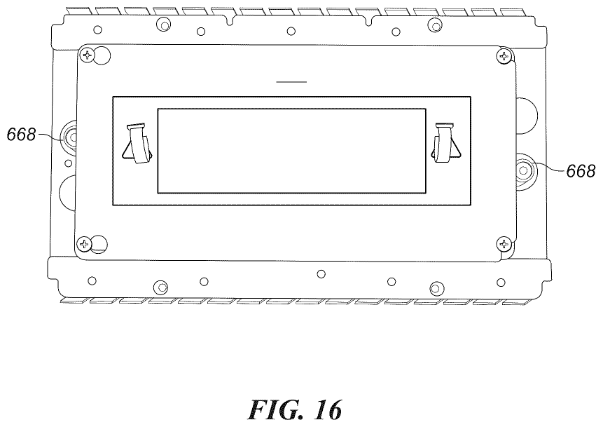

Referring to FIG. 13, a pictorial representation of a line extender 600 is illustrated. The line extender 600 is a 1 to 1 configuration to provide filter-amplified signals. The line extender 600 includes a substantial housing 610, which is conductive, that is interconnected to the network cable. The line extender 600 includes a power supply 620 attached to one half of the housing 610 and electronics 630 attached to the other half of the housing 610. The electronics 630 are included in a detachably engageable tray 640 that may be removed from the housing 610. Referring also to FIG. 14, a set of two coaxial cables are interconnected to the line extender 600 through respective ports. Referring also to FIG. 15 and FIG. 16, the cables are inserted through a respective opening 650 in the housing and secured to a respective adapter 660 secured within the housing 610. Referring also to FIG. 6, the tray 640 of electronics 630 may include a corresponding set of connectors 668 that are detachably engageable with the adapters 660.

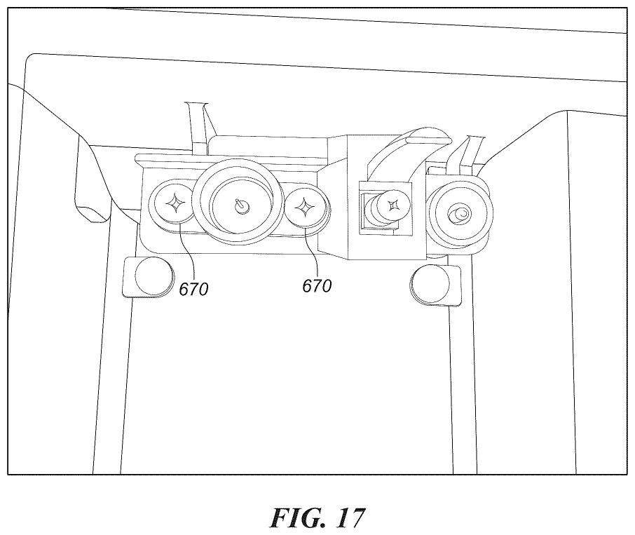

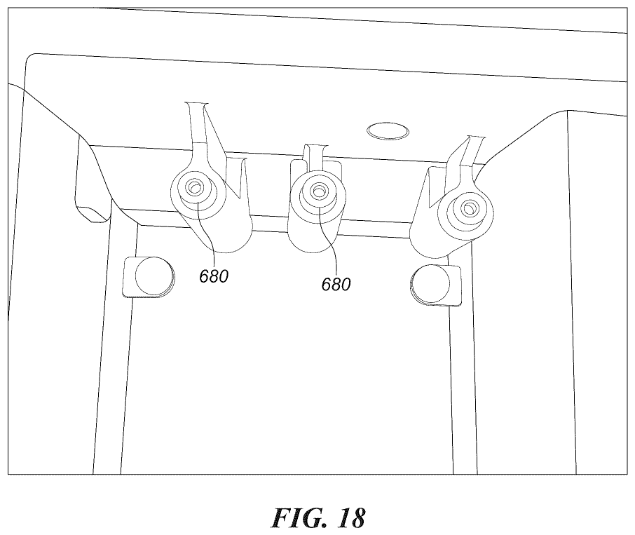

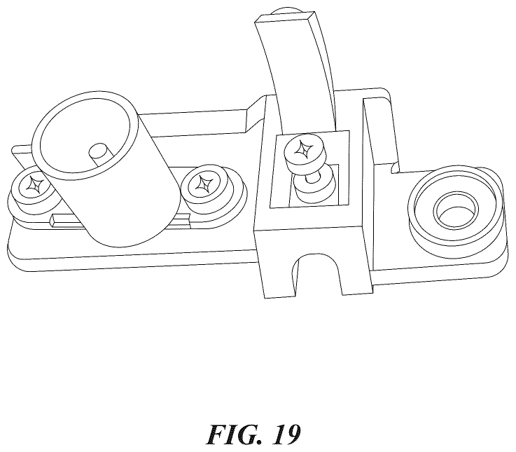

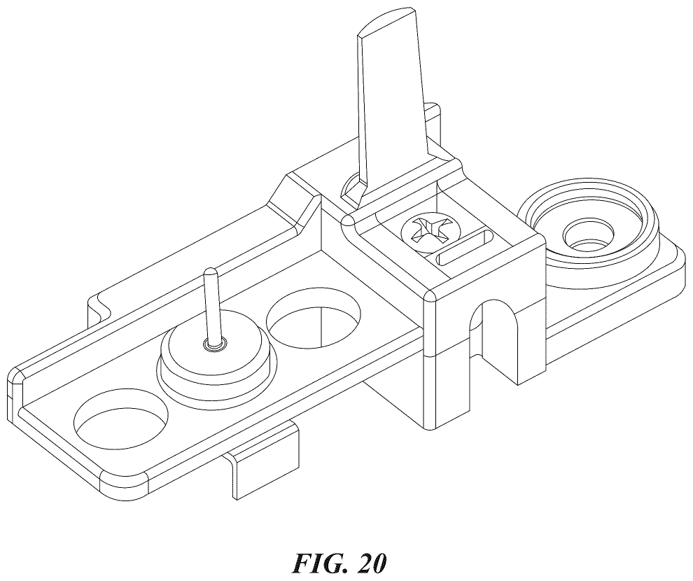

Referring to FIG. 17 and FIG. 18, the adapter 660 is secured to the housing by a pair of screws 670 into threaded mounts 680. In this manner the adapter 660 is secured to the housing in a manner that also inhibits rotation. Also referring to FIG. 19 and FIG. 20, the adapter 660 includes a central conductor that is engaged with the connector 668.

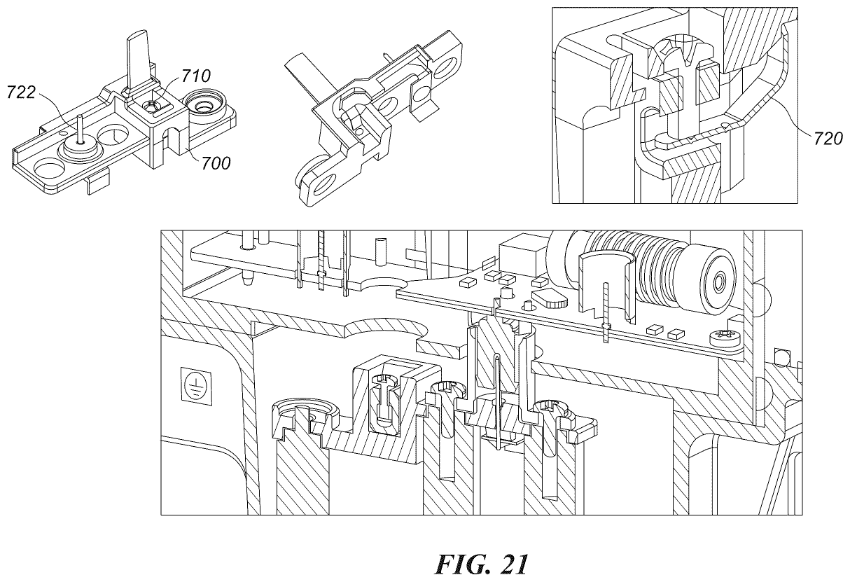

Further referring to FIG. 21, the adapter 660 receives the central “stinger” conductor of the cable with within a rectangular enclosure 700. The central “stinger” conductor is secured in place with a conductive threaded screw 710. The central “stinger” conductor is pressed onto a conductive flexible metal member 720 which forms a conductive path to a center prong 722 of a connector. The sheath of the coaxial cable, which provides a ground reference potential, is secured to the housing 610, which likewise provides the housing as a ground reference potential. The housing 610 is electrically interconnected to the threaded mounts 680, which are electrically interconnected to the screws 670, which are electrically interconnected to the exterior portion of the connector that includes the center prong. In this manner, the ground potential is provided from the sheath of the cable, through respective portions of the housing, and to the electronics.

The resulting port entry structure is illustrated showing the signal path and the ground path between the coaxial cable and the electronics enclosed therein.

As the data carrying capacity of the DOCSIS based network increases over time, the frequencies that are used to carry the data are increased, such as higher frequencies from 1.2 GHz to 1.8 GHz, and such as higher frequencies from 1.2 GHz to 3.0 GHz. With this increase in frequency to support ever increasing data carrying capacity, it was determined that the physical cable has the capability of carrying such data with sufficient signal integrity and the electronics included within the enclosure likewise has the capability of carrying such data with sufficient signal integrity. However, it was determined that the port entry adapter that engages with the housing to interconnect the cable with the electronics includes characteristics that inhibit its ability to effectively carry data at such increased frequencies.

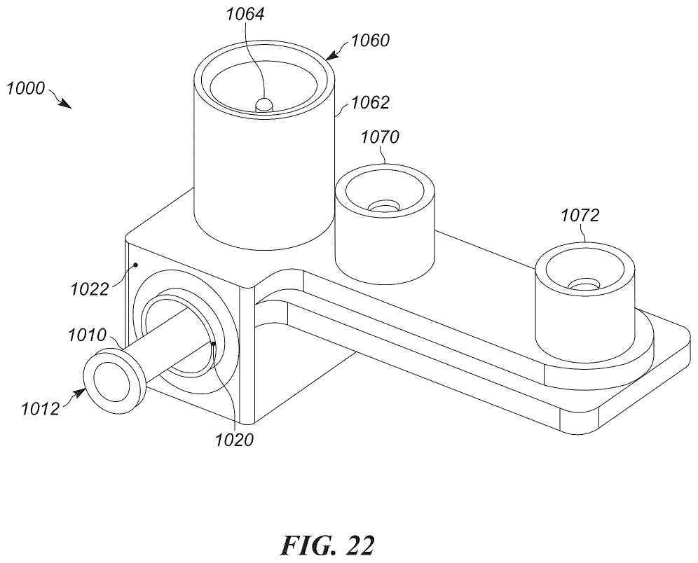

Referring to FIG. 22, a modified port entry adapter 1000 includes an elongate dielectric tube 1010 that includes a flared terminal portion 1012. The elongate tube 1010 including the flared portion 1012 thereof, is sized to fit within the circular opening of an existing housing, such as those shown in FIG. 5 and FIG. 15. Typically, the flared portion 1012 is sized to engage with the interior walls of the circular opening of the existing housing while the majority of the elongate tube 1010 maintains a spaced offset from the walls of the circular opening with an air gap therebetween. In particular, it is desirable that the elongate tube 1010 is sized to fit within the circular opening and be positioned within the circular opening from the interior of the existing housing. In this manner, if an enclosure already has a coaxial cable already connected thereto with a central “stinger” core extending within the housing, then the elongate tube 1010 may be placed over the central core of the coaxial cable from the interior of the housing. In this manner, if an enclosure does not already have a coaxial cable already connected thereto and therefore without a central “stinger” core extending within the housing, then the elongate tube 1010 may be positioned within the circular opening from either the interior or the exterior of the housing, depending on convenience. The tubular opening defined by the elongate tube 1010 is preferably slightly larger than the size of the central “stinger” core of the coaxial cable so that the central “stinger” core is maintained in a desired position and not subject to significant movement because of vibrations imparted on the housing.

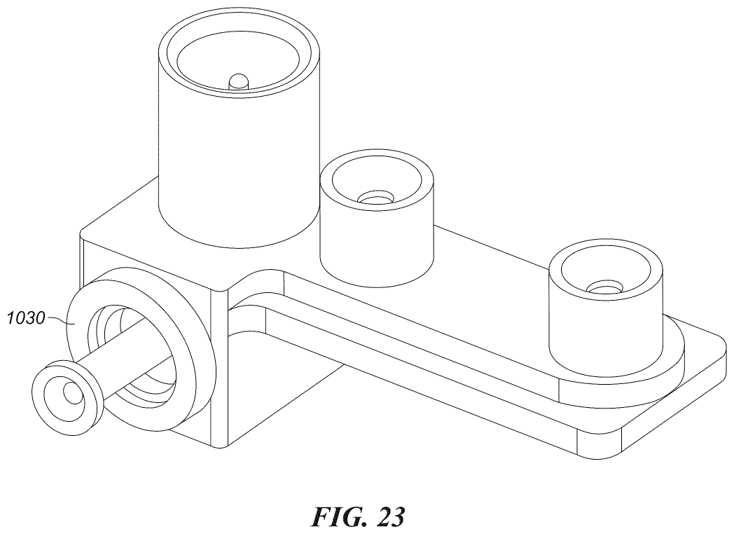

The port entry adapter 1000 may define a lip 1020 that protrudes from a face 1022 of the modified port entry adapter 1000. Referring also to FIG. 23, to provide an improved electrical interconnection between the port entry adapter 1000 and the housing, a compressible conductive material 1030, such as a conductive mesh, may be included. With the port entry adapter 1000 in pressing engagement with the housing, the compressible conductive material 1030 conforms to the two surfaces and provides an interconnection that is not significantly impaired by aging, vibration, movement, or otherwise. Preferably, the compressible conductive material 1030 is interconnected with the face 1022 by glue or other adhesive material. The sheath of the coaxial cable has a ground reference potential which is terminated by the exterior of the conductive housing which then likewise has a ground reference potential. A short electrical path exists through the housing to the compressible conductive material 1030 that then likewise has a ground reference potential. The compressible conductive material 1030 then is electrically interconnected to the port entry adapter 1000 which is a conductive member and/or the lip portion is a conductive member and/or other electrical structure is a conductive member that provides a ground reference potential along the electrical signal path within the port entry adapter 1000.

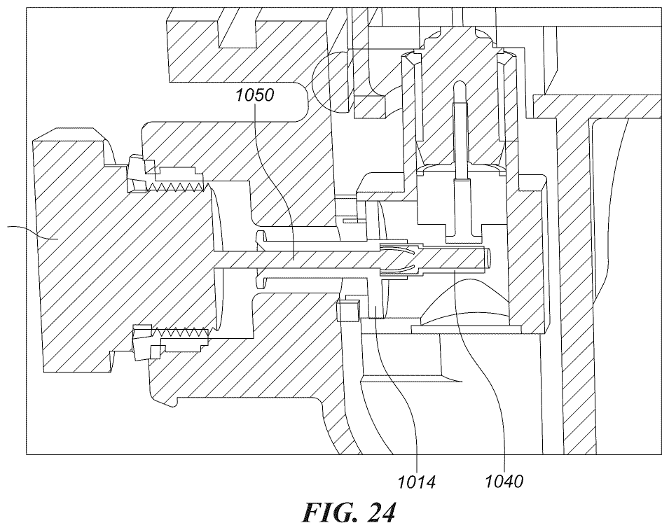

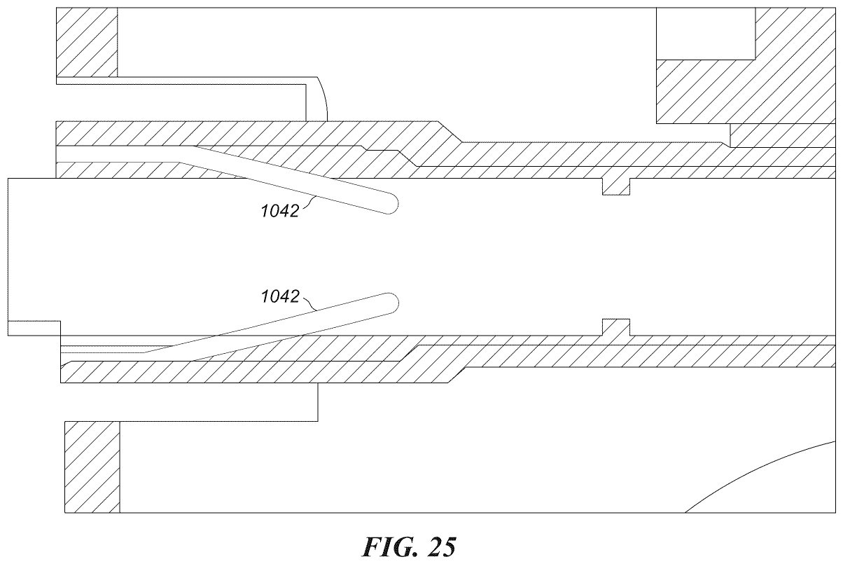

Referring also to FIG. 24, within the port entry adapter 1000 is included a circular conductive press fit retention structure 1040. The press fit retention structure 1040 is sized to receive the central “stinger” core 1050 of the coaxial cable so that a secure electrical interconnection may be made, without integrity issues related to a screw securement mechanism. Referring also to FIG. 25, the press fit retention structure 1040 may include one or more electrical resilient prongs 1042 which engage the central “stinger” core 1050 of the coaxial cable. The elongate tube 1010 preferably includes an interior flange 1014 that forms a weatherproof seal against the interior structures of the port entry adapter 1000.

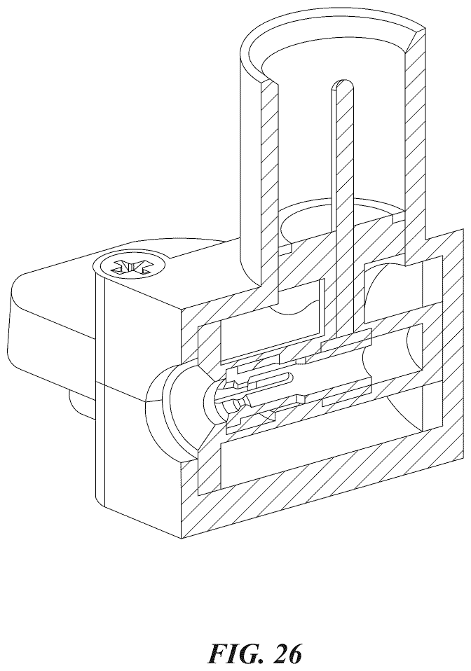

Referring to FIG. 26, a sectional view of the port entry adapter 1000 is illustrated.

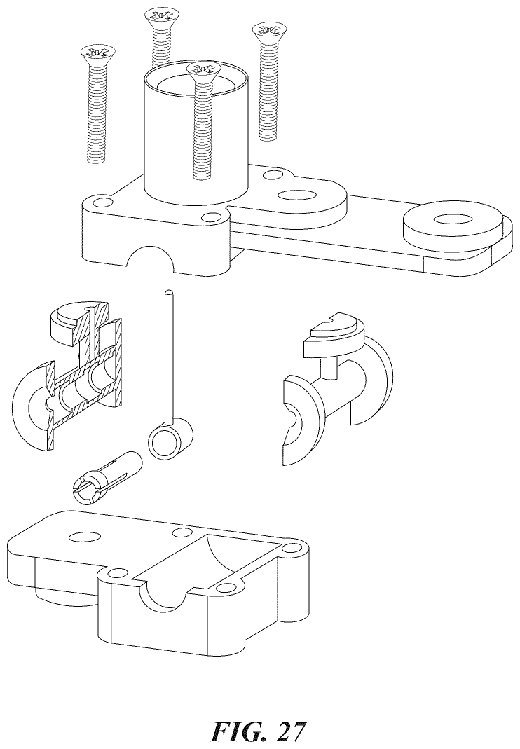

Referring to FIG. 27, an exploded view of the port entry adapter 1000 is illustrated. It is noted that the horizontal elongate dielectric tube and the vertical conductor of the connector are preferably at substantially 90 degrees with respect to one another.

The port entry adapter 1000 may include a vertical press fit connector 1060. The vertical press fit connector 1060 includes a circular exterior conductor 1062 and an interior central conductor 1064. The electronics within the enclosure include a corresponding connector that press fits within the vertical press fit connector.

The port entry adapter 1000 includes a pair of spaced apart screw supports 1070, 1072 that define openings therein. A pair of screws may be engaged with the screw supports 1070, 1072 to engage with a pair of matching threaded openings defined by the housings, such as those illustrated in FIG. 5 and FIG. 15. By including a pair of spaced apart screw openings with spaced apart screws, the port entry adapter 1000 is suitable to be inhibited from rotational movement.

The impedance of the coaxial cable is preferably 75 ohms, with a preferred range between 70 ohms and 80 ohms. In this manner, the coaxial cable provides a controlled impedance structure, preferably in a range of 40 MHz to 1.8 GHz, or in the range of 40 MHz to 3.0 GHz.

The impedance of the receiving portions of the electronics is preferably 75 ohms, with a preferred range between 65 ohms and 85 ohms. In this manner, the receiving portions of the electronics provides a controlled impedance structure, preferably in a range of 40 MHz to 1.8 GHz, or in the range of 40 MHz to 3.0 GHz.

The impedance of the port entry adapter 1000 is preferably 75 ohms, with a preferred range between 55 ohms and 95 ohms, and more preferably with a range between 65 ohms and 85 ohms. In this manner, the port entry adapter 1000 provides a controlled impedance structure, preferably in a range of 40 MHz to 1.8 GHz, or in the range of 40 MHz to 3.0 GHz.

The port entry adapter 1000 with the ground path being generally aligned with the signal path through the port from the coaxial cable to the electronics therein, facilitates an improved controlled impedance path which in turn results in an improvement in the frequency response characteristics of the port entry adapter 1000.

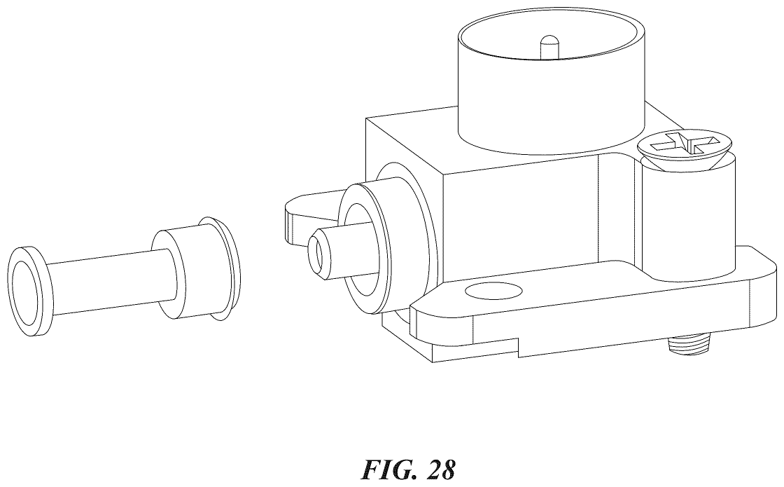

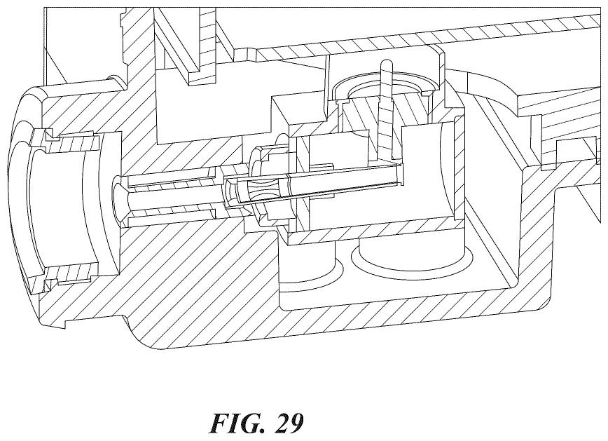

Referring to FIG. 28 and FIG. 29, another modified port entry adapter 1000 includes an elongate tube together with a press fit retention structure.

Moreover, each functional block or various features in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A port entry adapter comprising:
(a) said port entry adapter including an elongate dielectric housing oriented in a horizontal orientation and sized with an opening defined therein to engage a horizontally oriented conductor of a coaxial cable extending through a housing;
(b) said port entry adapter including a compressible conductive member oriented in said horizontal orientation on a face thereof positioned in such a manner that when said elongate dielectric housing is engaged with said horizontally oriented conductor of said coaxial cable extending through said housing said compressible conductive member is in compressed electrical interconnection with an interior surface of said housing;
(c) said port entry adapter including a conductive press fit retention structure suitable for engaging said horizontally oriented conductor of said coaxial cable extending through said housing;
(d) said port entry adapter including a vertically oriented connector that includes a conductive tubular member and a central conductive member located at a central position of said conductive tubular member;
(e) said horizontally oriented elongate dielectric housing oriented at an angle of substantially 90 degrees with respect to said vertically oriented connector;
(f) said vertically oriented connector is a press fit connector configured to form an electrical with electronics included within said housing;
(g) said port entry adapter configured to provide a controlled impedance structure between a signal path and a ground reference potential of between 55 ohms and 95 ohms within a range of 40 MHz to 1.8 GHz.

2. The port entry adapter of claim 1 wherein said elongate dielectric housing including a first flared terminal portion.

3. The port entry adapter of claim 1 wherein said elongate dielectric housing including a central portion having a smaller outer diameter than an outer diameter of said flared terminal portion.

4. The port entry adapter of claim 1 further comprising a protruding lip engaging said compressible conductive member.

5. The port entry adapter of claim 1 further comprising said conductive press fit retention structure further comprising a conductive resilient conductive member that engages said horizontally oriented conductor of said coaxial cable extending through said housing.

6. The port entry adapter of claim 1 further comprising a central axis of said horizontally oriented elongate dielectric housing aligned with said central conductive member.

7. The port entry adapter of claim 1 defining a pair of spaced apart opening suitable for securing a pair of screws therethrough to secure said port entry adapter to said enclosure.

8. The port entry adapter of claim 1 wherein said elongate dielectric housing including a second flared terminal portion having a larger diameter than said first flared terminal portion.

9. The port entry adapter of claim 1 wherein said port entry adapter configured to provide said controlled impedance structure between said signal path and said ground reference potential of between 65 ohms and 85 ohms within a range of 40 MHz to 1.8 GHz.

10. The port entry adapter of claim 1 wherein said port entry adapter configured to provide said controlled impedance structure between said signal path and said ground reference potential of between 65 ohms and 85 ohms within a range of 40 MHz to 3.0 GHz.

11. The port entry adapter of claim 1 wherein said port entry adapter configured to provide said controlled impedance structure between said signal path and said ground reference potential of between 55 ohms and 95 ohms within a range of 40 MHz to 3.0 GHz.
